(19) United States
(12) Patent Application Publication
(10) Pub. No.: US 2025/0144474 A1
(43) Pub. Date: May 8, 2025

(54) SENSING AND ADAPTATION DEVICE FOR EXERCISE AND METHOD THEREOF

(71) Applicant: INSTITUTE FOR INFORMATION INDUSTRY, TAIPEI CITY (TW)

(72) Inventors: Zhi-Ying CHEN, TAIPEI CITY (TW); Jia-Hao WANG, TAIPEI CITY (TW); Yun-Cheng JHONG, TAIPEI CITY (TW); Chia-Hung TSENG, TAIPEI CITY (TW); Chien-Der LIN, TAIPEI CITY (TW)

(73) Assignee: INSTITUTE FOR INFORMATION INDUSTRY, TAIPEI CITY (TW)

(21) Appl. No.: 18/524,553

(22) Filed: Nov. 30, 2023

(30) Foreign Application Priority Data
Nov. 3, 2023 (TW) 112142345

(51) Int. Cl. A63B 24/00; A63F 13/21; A63F 13/816

(52) U.S. Cl. CPC A63B 24/0087; A63F 13/21; A63F 13/816; A63B 2024/0068; A63B 2024/0078; A63B 2024/0093; A63B 2220/51; A63B 2220/62; A63B 2225/50

(57) ABSTRACT

Provided is a sensing and adaptation method for exercise. The method is applied to a sensing and adaptation device for exercise and includes the following steps: generating an exercise game and a first resistance setting to an exercise equipment according to a first exercise target data; receiving an exercise interactive data of a user operating the exercise game from the exercise equipment; generating a reaction-time data according to a stage data of the exercise game and the exercise interactive data and generating an operation trajectory data according to the first resistance setting, the stage data and the exercise interactive data; calculating a deviation degree of the operation trajectory data; calculating a second exercise target data according to the deviation degree; generating a second resistance setting and updating the exercise game according to the second exercise target, and transmitting the second resistance setting to the exercise equipment.

### CROSS-REFERENCE TO RELATED APPLICATIONS

This application claims the priority benefit of TW application serial No. 112142345 filed on Nov. 3, 2023. The entirety of the above-mentioned patent application is hereby incorporated by reference herein and made a part of the specification.

### BACKGROUND OF THE INVENTION

### 1. Field of the Invention

The present invention relates to a sensing and adaptation device and a method thereof, and more particularly to a sensing and adaptation device for exercise and a method thereof that can improve efficiency of exercise and fitness.

### 2. Description of the Related Art

Exercise not only strengthens bodies, but also helps users with physical injuries, degeneration (e.g., muscle loss) or disability to recover their body functions. To effectively quantify a time and an intensity of exercise, current exercise plannings mostly use a fixed operating weight or resistance combined with a frequency and a time of operating an exercise equipment to set exercise targets and evaluate exercise efficacy.

However, the users may be unable to immediately complete the expected exercise targets. When a target weight set by the exercise equipment is too heavy, the users will be unable to complete the exercise targets due to pain or muscle fatigue. If the users operate the exercise equipment continually, the muscle fatigue will gradually increase, making the users hard to operate the exercise equipment or hard to balance a force exerted by muscle groups when operating the exercise equipment. Since the current exercise equipment cannot dynamically adjust an exercise intensity (such as weight, frequency, time) according to physical and mental conditions of the users, exercise benefits will be affected and a boring exercise process will further increase a psychological pressure of the users and affect their willingness to exercise.

### SUMMARY OF THE INVENTION

The present invention provides a sensing and adaptation device for exercise to solve the above problems by dynamically adjusting exercise targets according to exercise status of users.

The sensing and adaptation device of the present invention includes a receiving module, a sensing analysis module, a dynamic adaptation and game generating module and a transmitting module.

The receiving module is configured to receive an exercise interactive data of a user operating an exercise game on an exercise equipment. The exercise game is generated according to a first exercise target data and the exercise equipment is configured to control an operation resistance according to a first resistance setting.

The sensing analysis module is connected to the receiving module. The sensing analysis module is configured to generate a reaction-time data according to a stage data of the exercise game and the exercise interactive data, generate an operation trajectory data according to the stage data, the first resistance setting, and the exercise interactive data, calculate a deviation degree according to the operation trajectory data and calculate a second exercise target data according to the deviation degree.

The dynamic adaptation and game generating module is connected to the sensing analysis module. The dynamic adaptation and game generating module is configured to generate a second resistance setting and update the exercise game according to the second exercise target data.

The transmitting module is connected to the dynamic adaptation and game generating module. The transmitting module is configured to transmit the second resistance setting to the exercise equipment to control the operation resistance of the exercise equipment.

The present invention provides a sensing and adaptation method for exercise. The sensing and adaptation method is applied to a sensing and adaptation device for exercise and includes the following steps:
generating an exercise game and a first resistance setting to an exercise equipment according to a first exercise target data;
receiving an exercise interactive data of a user operating the exercise game from the exercise equipment;
generating a reaction-time data according to a stage data of the exercise game and the exercise interactive data and generating an operation trajectory data according to the stage data, the first resistance setting and the exercise interactive data;
calculating a deviation degree of the operation trajectory data;
calculating a second exercise target data according to the deviation degree;
generating a second resistance setting and updating the exercise game according to the second exercise target data, and transmitting the second resistance setting to the exercise equipment.

The present invention generates the exercise game and the first resistance setting according to the first exercise target data and controls the operation resistance of the exercise equipment according to the first resistance setting. The present invention analyzes the exercise interactive data of the user operating the exercise game on the exercise equipment and further analyzes whether the current exercise target is suitable for physical functions of the users according to the reaction-time data and the operation trajectory data. The present invention can instantly (or in real time) assist the user to dynamically calculate and adjust a new exercise target during exercise (such as rehabilitation but not limited thereto). Compared with the conventional technology, the present invention not only integrates the exercise targets into the exercise game to increase the user's willingness of exercise, but also dynamically adjusts an exercise intensity of every user according to exercise status of the users, which helps to improve exercise efficiency.

### BRIEF DESCRIPTION OF THE DRAWINGS

FIG. 1 is a block diagram of the sensing and adaptation device for exercise of an embodiment of the present invention.

FIG. 2 is a block diagram of the sensing and adaptation device for exercise applied to the exercise equipment of an embodiment of the present invention.

FIG. 3 is a schematic diagram of a game screen of an exercise game of an embodiment of the present invention.

FIG. 4 is a schematic diagram of another game screen of an exercise game of an embodiment of the present invention.

FIG. 5 is a trajectory schematic diagram of the operation trajectory data of an embodiment of the present invention.

FIG. 6 is a trajectory schematic diagram of the operation trajectory data of an embodiment of the present invention.

FIG. 7 is a flow chart of the sensing and adaptation method for exercise of an embodiment of the present invention.

FIG. 8 is a flow chart of the sensing and adaptation method for exercise of an embodiment of the present invention.

### DETAILED DESCRIPTION OF THE INVENTION

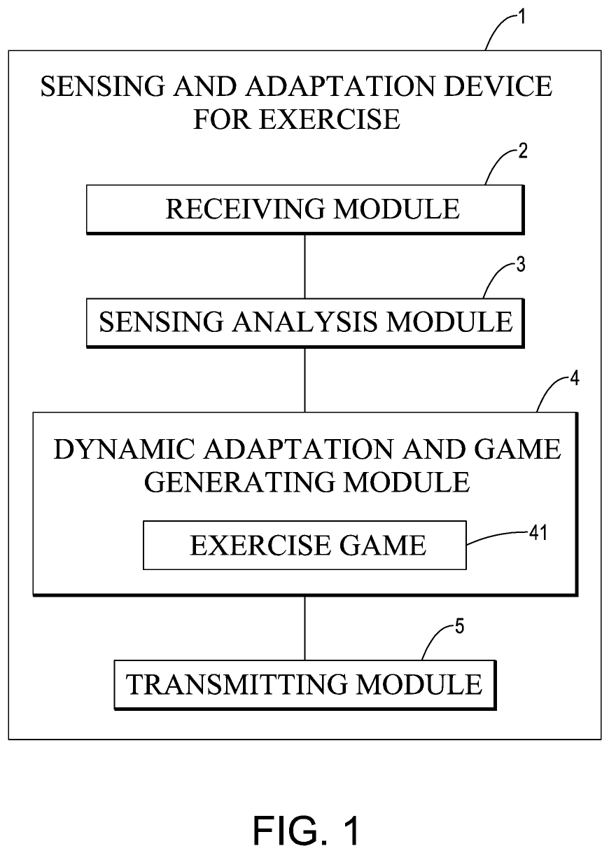

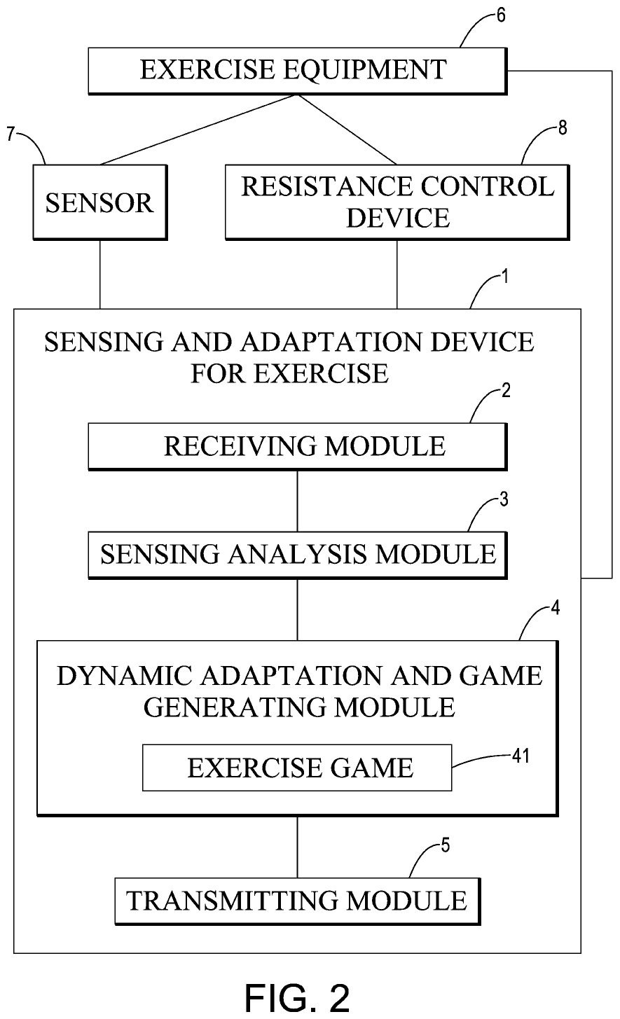

With reference to FIG. 1, FIG. 1 is a block diagram of a sensing and adaptation device for exercise 1 of an embodiment of the present invention. The sensing and adaptation device 1 includes a receiving module 2, a sensing analysis module 3, a dynamic adaptation and game generating module 4 and a transmitting module 5. With reference to FIG. 2, FIG. 2 is a block diagram of the sensing and adaptation device 1 and an exercise equipment 6 of an embodiment of the present invention. The exercise equipment 6 can be provided with a sensor 7 and a resistance control device 8. The sensing and adaptation device 1 can be connected to the exercise equipment 6, the sensor 7 and the resistance control device 8. For instance, the sensing and adaptation device 1 can be communicatively connected to the sensor 7 and the resistance control device 8. When a user operates the exercise equipment 6, the sensing and adaptation device 1 can be used to assist the user to dynamically adjust an exercise intensity. The sensing and adaptation device 1 can be mounted on the exercise equipment 6 or can be separately disposed from the exercise equipment 6.

In an embodiment, the dynamic adaptation and game generating module 4 generates an exercise game 41 and a first resistance setting according to a first exercise target data, and transmits the exercise game 41 and the first resistance setting to the exercise equipment 6 through the transmitting module 5. The exercise game 41 is used to provide exercise stages for the user to perform somatosensory interactions. The user performs the exercise game 41 corresponding to the first exercise target data through the exercise equipment 6 with the first resistance setting.

In an embodiment, the first exercise target data can correspond to exercise targets planned by a person who instructs the user to operate the exercise equipment 6, such as, but not limited to, a coach or a rehabilitation therapist. The first exercise target data can include at least one information of exercise items, an exercise intensity, an exercise weight, an exercise frequency and an exercise time, but the first exercise target data is not limited to such.

In an embodiment, the dynamic adaptation and game generating module 4 generates a stage data of the exercise game 41. The stage data can include at least one information of a stage starting time point, a stage ending time point, a target time, a target frequency, a target intensity and a stage situation, but the stage data is not limited to such.

In an embodiment, the sensor 7 and the resistance control device 8 are mounted on the exercise equipment 6. The exercise equipment 6 has a display screen to display any one of or a combination of the exercise game 41 and the above-mentioned first exercise target data, for the user to operate the exercise equipment 6.

The resistance control device 8 is connected to the exercise equipment 6 and the sensing and adaptation device 1 to set an operation resistance of the exercise equipment 6. The operation resistance of the exercise equipment 6 is a resistance that the user needs to overcome when operating the exercise equipment 6. In an embodiment, when the resistance control device 8 receives the first resistance setting from the transmitting module 5 of the sensing and adaptation device 1, the resistance control device 8 sets the operation resistance of the exercise equipment 6 according to the first resistance setting, for the user to operate the exercise equipment 6 according to the first resistance setting.

The sensor 7 is connected to the exercise equipment 6 and the sensing and adaptation device 1 to sense an exercise interactive data of the user operating the exercise equipment 6. In an embodiment, the exercise interactive data can include at least one information of an operation position, an operation distance, an operation angle, an operation direction, an operation force, an operation starting time point, an operation ending time point and an operation speed when operating the exercise equipment 6, but the exercise interactive data is not limited to such. In other embodiments, the sensor 7 can be an inertial measurement unit (IMU). In other embodiments, the sensor 7 can perform data transmission with the exercise equipment 6 and/or the sensing and adaptation device 1 through a wireless communication technology. The wireless communication technology can be a short-range wireless communication technology (such as but not limited to Bluetooth or evolutions of the Bluetooth), an Internet of Things wireless communication technology suitable for the exercise equipment 6 (such as but not limited to an Advanced and Adaptive Network Technology (ANT) or evolutions of the ANT), but the wireless communication technology is not limited to such.

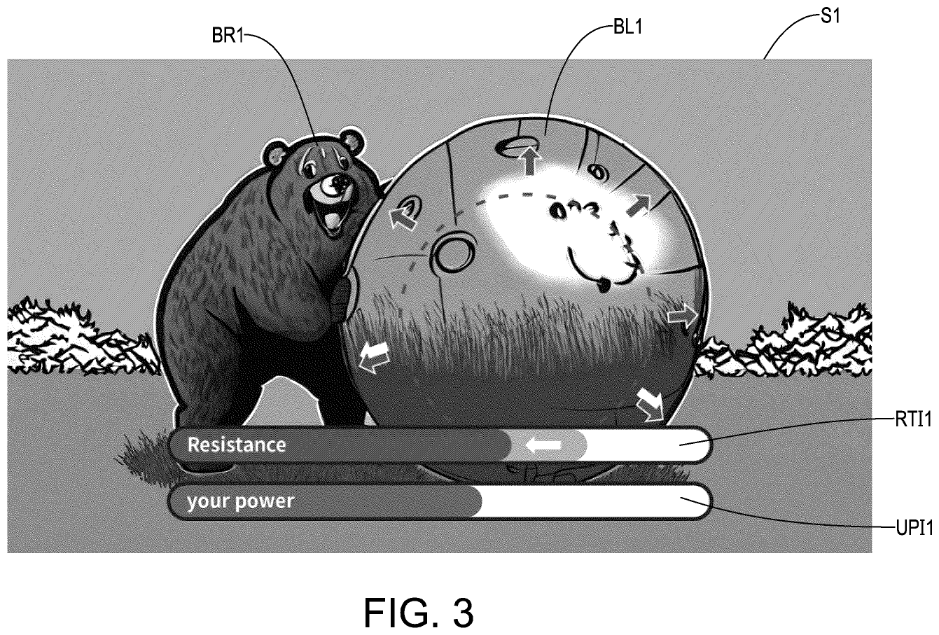

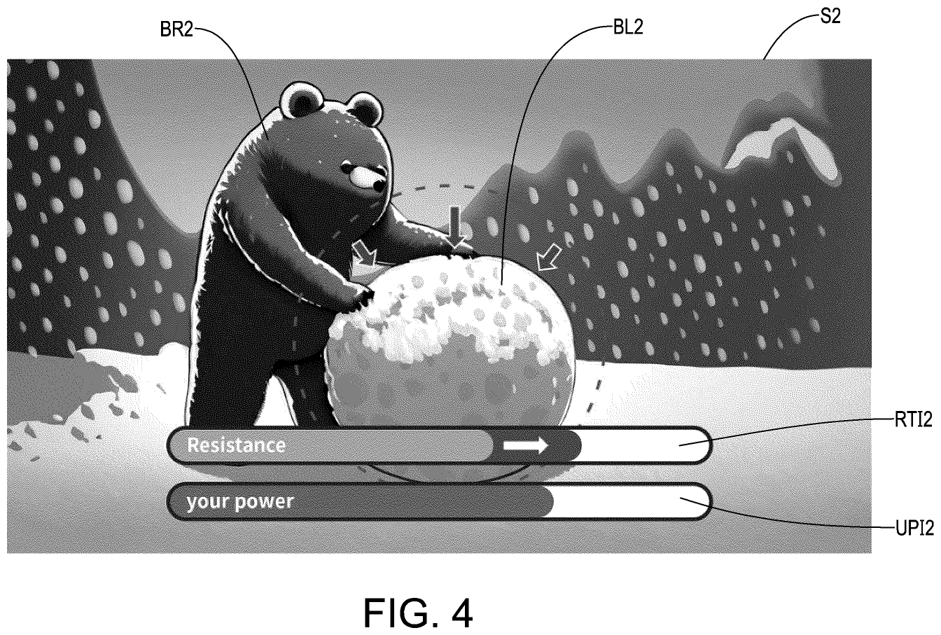

With reference to FIG. 3 and FIG. 4, FIG. 3 is a schematic diagram of a game screen S1 of the exercise game 41 of an embodiment of the present invention, and FIG. 4 is a schematic diagram of another game screen S2 of the exercise game 41 of an embodiment of the present invention. The exercise stage of the exercise game 41 includes operator objects BR1, BR2 representing the user, interactive objects BL1, BL2 representing objects operated by the user through the exercise equipment 6, resistance indicators RTI1, RTI2 and operator force indicators UPI1, UPI2.

Taking FIG. 3 for example, the user can operate the exercise equipment 6 according to a situation of the game screen S1 displayed by (e.g., by the display screen of) the exercise equipment 6, such that the operator object BR1 can push the interactive object BL1 in the game screen S1 according to the operation of the user, and the user can understand that a current force generated by the user is less than the current resistance of the exercise stage through the resistance indicator RTI1 and the operator force indicator UPI1.

Taking FIG. 4 for example, the user can operate the exercise equipment 6 according to a situation of the game screen S2 displayed by the exercise equipment 6, such that the operator object BR2 can push the interactive object BL2 in the game screen S2 according to the operation of the user, and the user can understand that the current force generated by the user is greater than the current resistance of the exercise stage through the resistance indicator RTI2 and the operator force indicator UPI2.

With reference to FIGS. 1 to 4, the sensing and adaptation device 1 can generate the exercise interactive data of the exercise game 41 according to the resistance indicator RTI1 and the operator force indicator UPI1 to obtain that the operator force indicator UPI1 is less than the operation resistance of the exercise stage. The sensing and adaptation device 1 can dynamically adjust the exercise intensity (e.g., adjust the resistance indicator RTI1 to the resistance indicator RTI2) and can update the exercise game 41 (e.g., update the game screen S1 to the game screen S2, updates the operator object BR1 to the operator object BR2 and updates the interactive object BL1 to the interactive object BL2).

The receiving module 2 is communicatively connected to the sensor 7 and the resistance control device 8, and connected to the sensing analysis module 3.

The receiving module 2 receives the exercise interactive data of the user operating the exercise equipment 6 from the sensor 7, receives the first resistance setting of the user operating the exercise equipment 6 from the resistance control device 8 and transmits the exercise interactive data and the first resistance setting to the sensing analysis module 3.

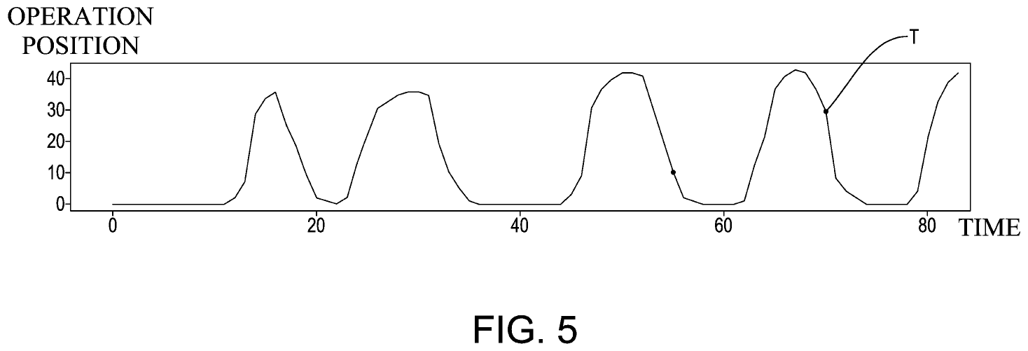

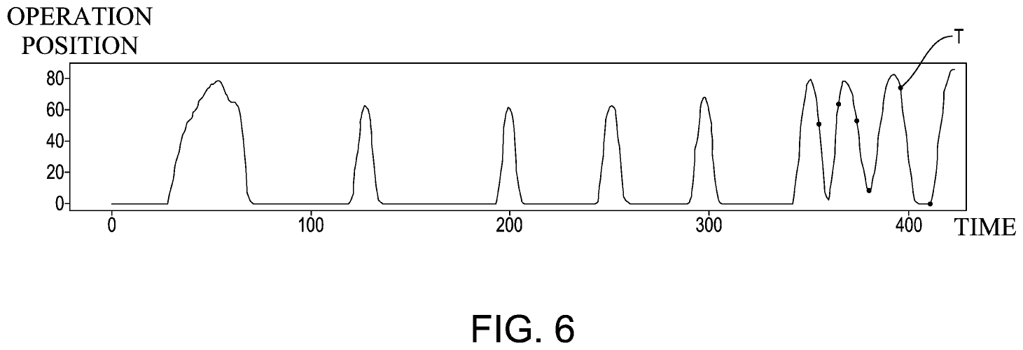

With reference to FIG. 5 and FIG. 6, FIG. 5 and FIG. 6 are respectively trajectory schematic diagrams of an operation trajectory data of embodiments of the present invention generated by the sensing and adaptation device 1. An X-axis of the trajectory schematic diagrams represents time, and a Y-axis of the trajectory schematic diagrams represents operating positions of the exercise equipment 6. Each point of the trajectory schematic diagrams represents a piece of the operation trajectory data and a waveform formed by the operation trajectory data represents an operation trajectory of the exercise equipment 6.

The sensing analysis module 3 calculates a time difference between a stage starting time point T of the stage data and an operation starting time point of the exercise interactive data by using a Flexible Dynamic Time Warping (FDTW) algorithm to generate a reaction-time data. The time difference between the stage starting time point T and the operation starting time point is a reaction-time from a time point of the user viewing the exercise stage starting to a time point of the user actually operating the exercise equipment 6.

With reference to FIG. 5 and FIG. 6, the sensing analysis module 3 uses the FDTW algorithm to calculate the operation trajectory data of the user operating the exercise game 41 on the exercise equipment 6 according to the stage data, the first resistance setting, and the exercise interactive data. In an embodiment, the operation trajectory data records the operation positions of the exercise equipment 6 at each time point and a stage starting time point T of every exercise stage.

The sensing analysis module 3 calculates an operation velocity change of the user operating the exercise equipment 6 per unit time according to an operation position change of the exercise equipment 6 per unit time in the operation trajectory data. The sensing analysis module 3 calculates an operation acceleration of the user operating the exercise equipment 6 per unit time according to the operation velocity change per unit time. The sensing analysis module 3 further calculates an operation force per unit time according to the operation acceleration and the first resistance setting per unit time to generate an operation force data corresponding to the exercise interactive data.

Furthermore, the sensing analysis module 3 analyzes a target achievement result of the first exercise target data according to the stage data, the reaction-time data, the operation trajectory data, and the operation force data. In an embodiment, since the stage data is generated by the first exercise target data, the sensing analysis module 3 analyzes the target achievement result according to a compliance degree between the exercise target of the stage data and the operation time, the operation frequency and the operation force presented in the reaction-time data, the operation trajectory data, and the operation force data. In another embodiment, the target achievement result includes at least one of a target completion rate, a target completion progress, and a completion time length, but the target achievement result is not limited to such.

The sensing analysis module 3 compares the operation trajectory data to a normal distribution to calculate a deviation degree and calculates a second exercise target data capable of adjusting the operation trajectory data to the normal distribution according to the reaction-time data and the deviation degree. The sensing analysis module 3 transmits the second exercise target data, the reaction-time data, the operation trajectory data, the operation force data, and the target achievement result to the dynamic adaptation and game generating module 4.

It should be noted that, when muscles of the user are normal, the operation trajectory data mostly conforms to the normal distribution. However, when the user experiences muscle fatigue or is unable to exert force (e.g., lack of muscular strength or endurance), the operation trajectory data is prone to deviation, which represents that the user is unable to afford the current exercise intensity and/or the current exercise frequency. The exercise target needs to be adjusted.

Taking FIG. 5 and FIG. 6 for example, when the user operates the exercise equipment 6 multiple times to change the operation position of the exercise equipment 6, the operation trajectory data will display a trajectory with fluctuation. In the operation trajectory data of FIG. 5, waveforms generated by the continuous operation of the user operating the exercise equipment 6 have similar shapes and regular interval times, which means that the user can afford the operation resistance of the exercise equipment 6 and operate the exercise equipment 6 stably. In the operation trajectory data of FIG. 6, waveforms generated by the continuous operation of the user operating the exercise equipment 6 are greatly different and the interval times of the waveforms are getting shorter and shorter, which means that the user is unable to afford the operation resistance of the exercise equipment 6 and unable to operate the exercise equipment 6 stably as the operation time increases.

Preferably, when the sensing analysis module 3 sets the second exercise target data, a target difference between the first exercise target data and the second exercise target data is within an allowable range. The allowable range may be expressed as an actual value or a percentage of the first exercise target data. For example, if the allowable range is 10% and the first exercise target data indicates to exercise with an operating force of 20 kg, the second exercise target data can indicate to exercise with the operating force within 18 kg to 22 kg. The operating force shall not exceed 22 kg and shall not be less than 18 kg.

The dynamic adaptation and game generating module 4 is connected to the sensing analysis module 3. The dynamic adaptation and game generating module 4 generates a second resistance setting according to the second exercise target data and updates the exercise game 41 according to the second exercise target data and the stage data. The transmitting module 5 is connected to the dynamic adaptation and game generating module 4. The dynamic adaptation and game generating module 4 transmits the second resistance setting to the resistance control device 8 through the transmitting module 5 to set the operation resistance that is consistent with the second resistance setting of the exercise equipment 6 and transmits the updated exercise game 41 to the exercise equipment 6.

Preferably, the dynamic adaptation and game generating module 4 adjusts a stage situation of the exercise stage according to the second exercise target data, to adjust at least one of background environments, sizes of the interactive objects and materials of the interactive objects according to a new exercise target, but the adjustment is not limited to such.

Taking FIG. 3 and FIG. 4 for example, in the game screen S1 of FIG. 3, the stage situation is a bear (i.e., the operator object BR1) pushing a larger iron ball (i.e., the interactive object BL1) on the grass. In the game screen S2 of FIG. 4, the stage situation is a bear (i.e., operator object BR2) pushing a smaller snowball (i.e., interactive object BL2) on the snowfield. In terms of visual effects, since the interactive object BL2 (snowball) in FIG. 4 is smaller and the material of the interactive object BL2 is snow, it may easily give the user a feeling that the interactive object BL2 in the game screen S2 (as shown in FIG. 4) is easier to push. Since the interactive object BL1 (iron ball) in FIG. 3 is larger and the material of the interactive object BL1 is metal, it may easily give the user a feeling that the interactive object BL1 in the game screen S1 (as shown in FIG. 3) is difficult to push.

When the dynamic adaptation and game generating module 4 adjusts the exercise target to increase the operation resistance of the exercise equipment 6 according to the second exercise target data, the dynamic adaptation and game generating module 4 can adjust the stage situation. To reduce a visual and psychological pressure caused by the game screen S1 and make the user more willing to try the exercise stage, the dynamic adaptation and game generating module 4 adjusts the stage situation of the game screen S2 in FIG. 4 to the stage situation of the game screen S1 in FIG. 3.

The dynamic adaptation and game generating module 4 not only updates the exercise game 41 and the operation resistance of the exercise equipment 6 according to the second exercise target data generated by the sensing analysis module 3, but also generates a somatosensory feedback of the exercise game 41 on the exercise equipment 6 and adjusts an object motion and a situation of the exercise game 41 according to the reaction-time data, the operation trajectory data and the operation force data generated by the sensing analysis module 3.

The dynamic adaptation and game generating module 4 uses a finite-state machine (FSM) algorithm to operate a virtual and real data conversion of the operation trajectory data and the operation force data. By the virtual and real data conversion, the dynamic adaptation and game generating module 4 converts the operation trajectory data and operation force data analyzed by the sensing analysis module 3 to the virtual exercise stage for calculation.

The dynamic adaptation and game generating module 4 performs a polynomial interpolation operation by combining the operation force data that has completed the virtual and real data converting with Vandermonde matrix algorithm. The dynamic adaptation and game generating module 4 calculates motion trajectories of the operator objects BR1, BR2 and the interactive objects BL1, BL2 in the exercise stage of the exercise game 41 by a complementary filtering. The motion trajectories are corresponding to the operation force data. The operator objects BR1, BR2 and the interactive objects BL1, BL2 in the game screen S1, S2 can move according to the corresponding motion trajectories increasing an authenticity of the somatosensory interaction in the exercise stage, improving a fidelity of the exercise stage, and helping to improve an immersion for the user participating in the exercise stage.

The dynamic adaptation and game generating module 4 generates a dynamic situation of the exercise stage by using a continuous collision detection (CCD) algorithm according to the stage situation of the exercise stage and the operation force data. The dynamic adaptation and game generating module 4 updates the stage data of the exercise stage according to the corresponding dynamic situation and makes the operator objects BR1, BR2 and the interactive objects BL1, BL2 in the exercise stage move according to the dynamic situation. For example, the dynamic adaptation and game generating module 4 calculates at least one of conditions of an object mass, a kinetic friction force and a static friction force that should be present when the operator objects BR1, BR2 and the interactive objects BL1, BL2 move in the exercise stage according to the original stage situation of one of the exercise stage and the analyzed operation force data, and displays the dynamic situation meeting the at least one of the conditions of the mass, the kinetic friction force and the static friction force in the game screens S1 and S2.

Taking FIG. 3 for example, the game screen S1 in FIG. 3 presents the stage situation about the operator object BR1 (e.g., the bear shown in FIG. 3) pushing the interactive object BL1 (e.g., the iron ball shown in FIG. 3) on the grass. The dynamic adaptation and game generating module 4 generates the dynamic situation of the exercise stage in FIG. 3 according to the stage situation and the operation force data which are corresponding to the game screen S1 and makes the interactive object BL1 move in a situation consistent with the iron ball rolling on the grass.

Taking FIG. 4 for example, the game screen S2 in FIG. 4 presents the stage situation about the operator object BR2 (e.g., the bear shown in FIG. 4) pushing the interactive object BL2 (e.g., the snowball shown in FIG. 4) on the snow. The dynamic adaptation and game generating module 4 generates the dynamic situation of the exercise stage in FIG. 4 according to the stage situation and the operation force data which are corresponding to the game screen S2 and makes the interactive object BL2 move in a situation consistent with the snow ball rolling on the snow.

The dynamic adaptation and game generating module 4 calculates a somatosensory feedback data conformed to the operation force data by an implicit Euler algorithm and a predictor-corrector algorithm. The dynamic adaptation and game generating module 4 generates a third resistance setting according to the somatosensory feedback data and transmits the third resistance setting to the resistance control device 8 to set the operation resistance of the exercise equipment 6 that is consistent with the somatosensory feedback data. For example, when the user operates the exercise equipment 6 and the dynamic adaptation and game generating module 4 makes the interactive objects BL1, BL2 move according to a motion trajectory, the interactive objects BL1, BL2 will receive a reverse resistance in reality if the interactive objects BL1, BL2 are hit. Therefore, the dynamic adaptation and game generating module 4 generates the third resistance setting according to the somatosensory feedback data and adjusts the operation resistance of the exercise equipment 6 according to the new resistance setting, so that when the user sees the interactive objects BL1, BL2 being impacted in the game screen S1, S2, the user will also feel an influence of the interactive objects BL1, BL2 due to the increased resistance.

In an embodiment, the dynamic adaptation and game generating module 4 generates an exercise report according to the past exercise interactive data, the reaction-time data, the operation trajectory data, the operation force data and the target achievement result. The exercise report can include at least one of a progress analysis, a target dynamic change, a target achievement analysis, and a muscle group exercising analysis, but the exercise report is not limited to such.

In an embodiment, the dynamic adaptation and game generating module 4 selects an exercise plan that meets the physical conditions of the user according to an exercise plan data, the reaction-time data, the operation trajectory data, the operation force data and the target achievement result and generates a recommended exercise plan for the user. The exercise plan data can include multiple exercise plans established by a person who instructs the user to operate the exercise equipment 6, such as, but not limited to, a coach or a rehabilitation therapist based on different physical functions.

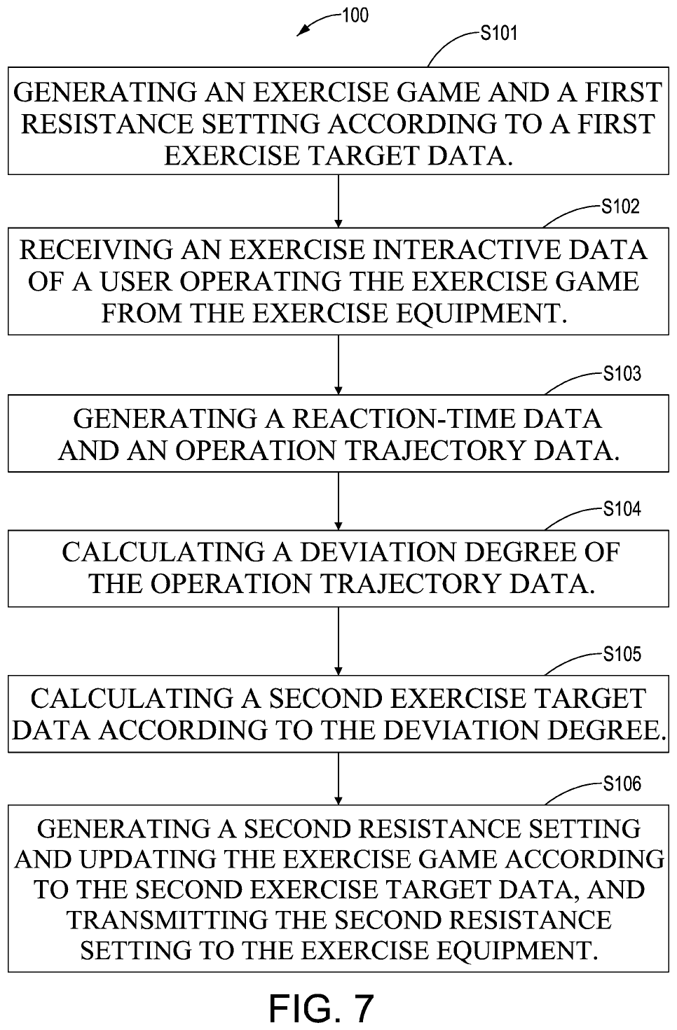

With reference to FIG. 7, FIG. 7 is a flow chart of the sensing and adaptation method for exercise 100 of an embodiment of the present invention. The sensing and adaptation method 100 is executed by the sensing and adaptation device 1 and is applied to an exercise equipment 6. The sensing and adaptation method 100 includes the following steps:

Step101: generating an exercise game 41 and a first resistance setting to the exercise equipment 6 according to a first exercise target data. The present invention sets the exercise equipment 6 according to the first resistance setting to set an operation resistance which is consistent with the first exercise target data and provides the exercise game 41 to the exercise equipment 6. The user can execute (e.g., play) the exercise game 41 on the exercise equipment 6 and operate the exercise equipment 6 to control objects in the exercise stage of the exercise game 41.

Step102: receiving an exercise interactive data of a user operating the exercise game 41 from the exercise equipment 6.

Step103: generating a reaction-time data according to a stage data of the exercise game 41 and the exercise interactive data and generating an operation trajectory data according to the stage data, the first resistance setting and the exercise interactive data. The step103 calculates a reaction-time of the user operating the exercise game 41 according to the stage data and the exercise interactive data and calculates the operation trajectory data of the exercise equipment 6 operating the exercise game 41 according to the stage data, the first resistance setting and the exercise interactive data.

Step104: calculating a deviation degree of the operation trajectory data. Wherein, the step104 calculates the deviation degree by comparing the operation trajectory data to a normal distribution.

Step105: calculating a second exercise target data according to the deviation degree. Wherein, the step105 calculates the second exercise target data capable of adjusting the operation trajectory data to match the normal distribution according to the deviation degree.

Step106: generating a second resistance setting and updating the exercise game 41 according to the second exercise target data, and transmitting the second resistance setting to the exercise equipment 6. Wherein, the step106 generates the second resistance setting and transmits the second resistance setting to the resistance control device 8 to set the operation resistance that is consistent with the second exercise target data of the exercise equipment 6, to update the stage situation of the exercise stage in the exercise game 41 and to update the corresponding stage data.

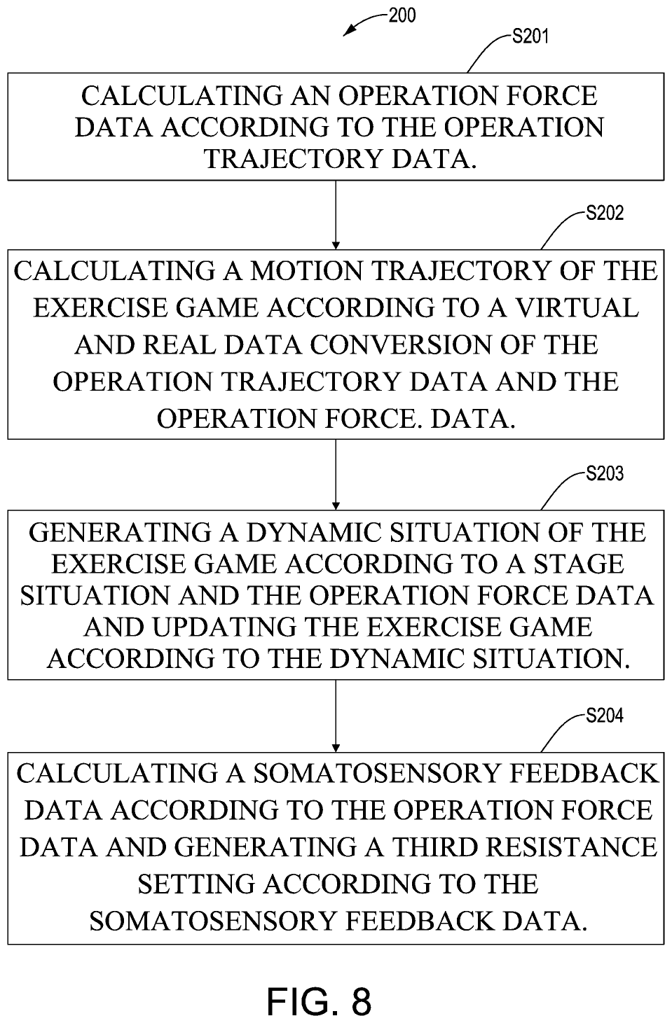

With reference to FIG. 8, FIG. 8 is a flow chart of the sensing and adaptation method for exercise 200 of an embodiment of the present invention. The sensing and adaptation method 200 is executed by the sensing and adaptation device 1 and is applied to an exercise equipment 6. The sensing and adaptation method 200 includes the following steps:

Step201: calculating an operation force data according to the operation trajectory data.

Step202: calculating a motion trajectory of the exercise game 41 according to a virtual and real data conversion of the operation trajectory data and the operation force data.

Step203: generating a dynamic situation of the exercise game 41 according to a stage situation of the stage data and the operation force data and updating the exercise game 41 according to the dynamic situation.

Step204: calculating a somatosensory feedback data according to the operation force data and generating a third resistance setting according to the somatosensory feedback data. The present invention sets the operation resistance that is consistent with the somatosensory feedback data according to the third resistance setting of the step204.

It should be noted that the modules in the sensing and adaptation device 1 can be implemented in many ways. For example, the above-mentioned modules can be integrated into one or more modules.

In addition, the modules can be implemented in hardware (such as circuits), software, firmware, or a combination thereof, but are not limited to such.

In addition, the steps of the sensing and adaptation methods 100, 200 can be computer programs or computer instructions that can be stored in a storage module (not shown in Figs.) of the sensing and adaptation device 1 to be read and executed by a processor (not shown in Figs.) of the sensing and adaptation device 1. The processor can be a central processing unit, a microprocessor or other processing devices suitable for reading the computer programs or the computer instructions. The storage module can be a read-only memory, a flash memory, a hard disk, an optical disk, a flash drive, or other data storage devices suitable for storing the computer programs or the computer instructions.

The above-mentioned “first”, “second” and “third” are only used to distinguish same statements, and are not used to limit any order between these statements or any order between the steps involved in these statements.

In the sensing and adaptation device 1 and the sensing and adaptation methods 100, 200 of the present invention, the dynamic adaptation and game generating module 4 generates the exercise game 41 according to a first exercise target data and sets the operation resistance of the exercise equipment 6 by the first resistance setting according to the first exercise target data. Compared with the boring exercise process of the conventional technology, the present invention integrates the exercise targets into the exercise game 41 to enhance willingness of the user for exercising (such as rehabilitation but not limited thereto) and reduce antipathy of the user for exercising through the interactive exercise stage.

Furthermore, the sensing analysis module 3 of the present invention analyzes the exercise interactive data of the user operating the exercise game 41 on the exercise equipment 6 and calculates the dynamic situation in the exercise stage of the exercise game 41 and the motion trajectory of every object in the exercise stage of the exercise game 41 according to multiple data generated by the analysis of the sensing analysis module 3. The sensing analysis module 3 adjusts the operation resistance of the exercise equipment 6 according to the somatosensory feedback data. The present invention not only makes the game screens S1, S2 of the exercise stages in the exercise game 41 more realistic, but also allows the user to immerse in the exercise game 41 through the somatosensory feedback data when operating the exercise equipment 6 to play the exercise game 41. The present invention can improve the fun and immersion during an exercise training and reduce a negative impression of the user for the exercise training.

The present invention further analyzes whether the current exercise target is suitable for physical functions of the user according to the reaction-time data and the operation trajectory data generated by the sensing analysis module 3. The present invention can instantly (or in real time) assist the user to dynamically calculate and adjust a new exercise target during exercise, which helps to improve an exercise efficiency.

What is claimed is:

1. A sensing and adaptation device for exercise, comprising:
a receiving module, configured to receive an exercise interactive data of a user operating an exercise game on an exercise equipment; wherein the exercise game is generated according to a first exercise target data and the exercise equipment is configured to control an operation resistance according to a first resistance setting;
a sensing analysis module, connected to the receiving module and configured to generate a reaction-time data according to a stage data of the exercise game and the exercise interactive data, generate an operation trajectory data according to the stage data, the first resistance setting, and the exercise interactive data, calculate a deviation degree according to the operation trajectory data, and calculate a second exercise target data according to the deviation degree;
a dynamic adaptation and game generating module, connected to the sensing analysis module and configured to generate a second resistance setting and update the exercise game according to the second exercise target data; and
a transmitting module, connected to the dynamic adaptation and game generating module and configured to transmit the second resistance setting to the exercise equipment to control the operation resistance of the exercise equipment.

2. The sensing and adaptation device as claimed in claim 1, wherein the receiving module is configured to receive the exercise interactive data of the user operating the exercise equipment through a measurement of an inertial measurement unit mounted on the exercise equipment.

3. The sensing and adaptation device as claimed in claim 1, wherein the receiving module is configured to receive the first resistance setting of the user operating the exercise equipment through a measurement of a resistance control device mounted on the exercise equipment.

4. The sensing and adaptation device as claimed in claim 1, wherein the sensing analysis module is configured to calculate a time difference between a stage starting time point of the stage data and an operation starting time point of the exercise interactive data to generate the reaction-time data.

5. The sensing and adaptation device as claimed in claim 1, wherein the sensing analysis module is configured to compare the operation trajectory data to a normal distribution to calculate the deviation degree, and calculate the second exercise target data capable of adjusting the operation trajectory data to match the normal distribution according to the deviation degree.

6. The sensing and adaptation device as claimed in claim 1, wherein an exercise stage of the exercise game comprises an operator object and an interactive object, the sensing analysis module is configured to calculate an operation force data according to the operation trajectory data, and the dynamic adaptation and game generating module is configured to perform the following operations:
calculating a motion trajectory of the operator object and the interactive object corresponding to the operation force data according to the operation trajectory data and the operation force data;
generating a dynamic situation of the exercise stage according to a stage situation of the stage data and the operation force data and updating the exercise game according to the dynamic situation; and
calculating a somatosensory feedback data according to the operation force data, generating a third resistance setting according to the somatosensory feedback data and transmitting the third resistance setting to the exercise equipment.

7. The sensing and adaptation device as claimed in claim 6, wherein the sensing analysis module is configured to analyze a target achievement result of the first exercise target data according to the stage data, the reaction-time data, the operation trajectory data, and the operation force data.

8. A sensing and adaptation method for exercise, applied to a sensing and adaptation device and comprising:
generating an exercise game and a first resistance setting to an exercise equipment according to a first exercise target data;
receiving an exercise interactive data of a user operating the exercise game from the exercise equipment;
generating a reaction-time data according to a stage data of the exercise game and the exercise interactive data and generating an operation trajectory data according to the stage data, the first resistance setting and the exercise interactive data;
calculating a deviation degree of the operation trajectory data;
calculating a second exercise target data according to the deviation degree;
generating a second resistance setting and updating the exercise game according to the second exercise target data, and transmitting the second resistance setting to the exercise equipment.

9. The sensing and adaptation method as claimed in claim 8, wherein calculating the deviation degree of the operation trajectory data and calculating the second exercise target data according to the deviation degree comprise:
calculating the deviation degree by comparing the operation trajectory data to a normal distribution and calculating the second exercise target data capable of adjusting the operation trajectory data to match the normal distribution according to the deviation degree.

10. The sensing and adaptation method as claimed in claim 8, further comprising:
calculating an operation force data according to the operation trajectory data;
calculating a motion trajectory of the exercise game according to the operation trajectory data and the operation force data;
generating a dynamic situation of the exercise game according to a stage situation of the stage data and the operation force data and updating the exercise game according to the dynamic situation;
calculating a somatosensory feedback data according to the operation force data;
generating a third resistance setting according to the somatosensory feedback data and transmitting the third resistance setting to the exercise equipment.

11. The sensing and adaptation method as claimed in claim 8, further comprising:
receiving the exercise interactive data of the user operating the exercise equipment through a measurement of an inertial measurement unit mounted on the exercise equipment.

12. The sensing and adaptation method as claimed in claim 8, further comprising:
receiving the first resistance setting of the user operating the exercise equipment through a measurement of a resistance control device mounted on the exercise equipment.

13. The sensing and adaptation method as claimed in claim 8, further comprising:
calculating a time difference between a stage starting time point of the stage data and an operation starting time point of the exercise interactive data to generate the reaction-time data.

14. The sensing and adaptation method as claimed in claim 10, further comprising:
analyzing a target achievement result of the first exercise target data according to the stage data, the reaction-time data, the operation trajectory data, and the operation force data.
